(19) United States
(12) Patent Application Publication
(10) Pub. No.: US 2018/0011513 A1
(43) Pub. Date: Jan. 11, 2018

(54) MOBILE TERMINAL

(71) Applicant: Wuhan China Star Optoelectronics Technology Co., Ltd., Wuhan, Hubei (CN)

(72) Inventors: Hongqing CUI, Shenzhen, Guangdong (CN); Xinhui ZHONG, Shenzhen, Guangdong (CN)

(73) Assignee: Wuhan China Star Optoelectronics Technology Co., Ltd., Wuhan, Hubei (CN)

(21) Appl. No.: 15/023,755

(22) PCT Filed: Mar. 4, 2016
(86) PCT No.: PCT/CN2016/075571

§ 371 Date: Mar. 22, 2016

(30) Foreign Application Priority Data
Feb. 2, 2016 (CN) 201610074366.2

(51) Int. Cl. G06F 1/16; G02F 1/1335; G06F 3/14

(52) U.S. Cl. CPC G06F 1/1647; G06F 3/1423; G02F 1/1335; H04M 2250/16; G09G 2360/04

(57) ABSTRACT

The present disclosure discloses a mobile terminal, including a first screen and a second screen; the first screen has a first display panel, the second screen has a second display panel, a direction of the first display panel and that of the second display panel are opposite, at least one of the first screen and the second screen is a reflection liquid crystal display, and when one of the screens is working, the other one is closed. By the method above, the disclosure can reduce energy consumption of the mobile terminal in some extent and improve endurance of the mobile terminal.

### FIELD OF THE DISCLOSURE

The present disclosure relates to a display technology field, and more particularly to a mobile terminal.

### BACKGROUND OF THE DISCLOSURE

With the development of electronic technique and internet technology, performance of an intelligent mobile terminal (such as a mobile phone, a tablet, etc.) is highly improved, which works in communication, reading, entertainment, and shopping, being indispensable to human life.

However, power consumption skyrockets with increasing usage of a mobile terminal, in both frequency and time, problems like a mobile phone out of power and frequently charging needed occur a lot. Otherwise, as the increasing demand of display quality, a screen of a mobile phone is apt to be high performances like high resolution, high contrast, wide color gamut, etc., which lead to a ratio of power consumption in the screen is raising.

As a result, a problem urged to be solved is how to prolong endurance of a mobile terminal.

### SUMMARY OF THE DISCLOSURE

The technical issue that the embodiment of the present disclosure solves is to provide a mobile terminal, which can reduce energy consumption of the mobile terminal in some extent and improve endurance of the mobile terminal.

To solve the technical problem above, a proposal offered by the disclosure is: providing a mobile terminal, including a first screen and a second screen; the first screen has a first display panel, the second screen has a second display panel, a direction of the first display panel and that of the second display panel are opposite, the first screen is a transmission liquid crystal display, the second screen is a reflection liquid crystal display, and when one of the first screen and the second screen displays, the other one is turned off; when the mobile terminal detects remaining capacity of a battery is lower than a first threshold, or detects present brightness is higher than a second threshold, or detects a user turning on an initial command of a preset application, the mobile terminal opts for the second screen to display an image.

The reflection liquid crystal display is a commonly white mode reflection liquid crystal display.

The reflection liquid crystal display includes: a first substrate with a reflecting layer; a second substrate; a liquid crystal layer between the first substrate and the second substrate; a polarizer disposed on the second substrate.

The reflection liquid crystal display further includes a quarter wave plate, the quarter wave plate is disposed in back of the polarizer in a direction of radiating light.

The reflection liquid crystal display further includes a half wave plate, the half wave plate is disposed between the quarter wave plate and the polarizer.

The reflection liquid crystal display includes a light source, the light source is disposed on a side of the reflection liquid crystal display.

A reflecting surface of the reflecting layer is concave-convex.

To solve the technical problem above, another proposal offered by the disclosure is: providing a mobile terminal, including a first screen and a second screen; the first screen has a first display panel, the second screen has a second display panel, a direction of the first display panel and that of the second display panel are opposite, at least one of the first screen and the second screen is a reflection liquid crystal display, and when one of the first screen and the second screen displays, the other one is turned off.

It further includes a control switch, applied to select the first screen or the second screen to display an image.

The control switch is applied to select the second screen to display in one of following conditions, and retain the first screen closed: remaining capacity of a battery the of mobile terminal lower than a first threshold; the mobile terminal under the circumstances that brightness is higher than a second threshold; the mobile terminal running a preset application.

The first screen is a transmission liquid crystal display, the second screen is a reflection liquid crystal display.

The reflection liquid crystal display is a commonly white mode reflection liquid crystal display.

The reflection liquid crystal display includes: a first substrate with a reflecting layer; a second substrate; a liquid crystal layer between the first substrate and the second substrate; a polarizer disposed on the second substrate.

The reflection liquid crystal display further includes a quarter wave plate, the quarter wave plate is disposed in back of the polarizer in a direction of radiating light.

The reflection liquid crystal display further includes a half wave plate, the half wave plate is disposed between the quarter wave plate and the polarizer.

The reflection liquid crystal display includes a light source, the light source is disposed on a side of the reflection liquid crystal display.

A reflecting surface of the reflecting layer is concave-convex.

Advantages of the disclosure: distinguishing from a conventional technique, the mobile terminal of the disclosure includes a first screen and a second screen, the two screens are opposite, at least one of them is a reflection liquid crystal display, and when one of the first screen and the second screen displays, the other one is turned off, since the reflection liquid crystal display can show an image relying on brightness of surroundings to radiate the screen, when the mobile terminal is with low battery or only for reading (such as reading an e-book), a user can select the reflection liquid crystal display, which can reduce energy consumption of the backlight, in order to reduce the energy consumption of the mobile terminal and prolong endurance.

### BRIEF DESCRIPTION OF THE DRAWINGS

FIG. 1 is a front view of a mobile terminal according to an embodiment of the present disclosure;

FIG. 2 is a back view of a mobile terminal according to an embodiment of the present disclosure;

FIG. 3 is a cross-sectional view of the mobile terminal shown in FIG. 1 taking along line AB;

FIG. 4 is a structural view of a second screen according to an embodiment of the present disclosure;

FIG. 5 is a directional view of a penetration axis of a polarizer, fast axes of a quarter wave plate and a half wave plate, an alignment of a liquid crystal layer in the second screen shown in FIG. 4;

FIG. 6 is a structural view of a second screen according to another embodiment of the present disclosure.

### DETAILED DESCRIPTION OF PREFERRED EMBODIMENTS

Embodiments of the present disclosure are described in detail with reference to the accompanying drawings as follows.

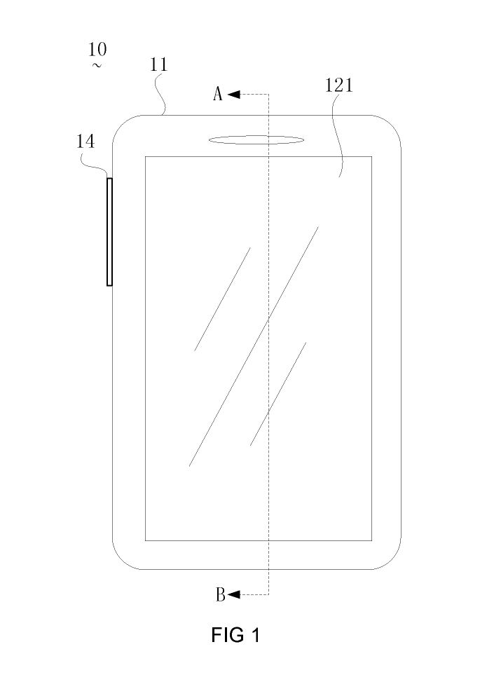

Referring to FIGS. 1-3, in a mobile terminal according to an embodiment of the disclosure, the mobile terminal 10 includes a shell 11, a first screen 12 and a second screen 13.

The first screen 12 and the second screen 13 are fixed in the shell 11. The first screen 12 has a first display panel 121, the second screen 13 has a second display panel 131, a direction of the first display panel 121 and that of the second display panel 131 are opposite. The first display panel 121 can be disposed in front of the mobile terminal 10, the second display panel can be disposed in back of the mobile terminal 10, the front side and the back side of the mobile terminal 10 are opposite.

At least one of the first screen 12 and the second screen 13 is a reflection liquid crystal display, and when one of the first screen 12 and the second screen 13 displays, the other one is turned off.

In the embodiment, two screens 12, 13 are disposed, one of which is a reflection liquid crystal display, consequently when the mobile terminal is low battery or only for reading (such as reading an e-book), a user can select the reflection liquid crystal display. As a reflection liquid crystal display can show an image relying on surrounding light to radiate the screen, a backlight is unnecessary, which can reduce energy consumption of the backlight when a reflection liquid crystal display works, in order to reduce the energy consumption of the mobile terminal and prolong endurance.

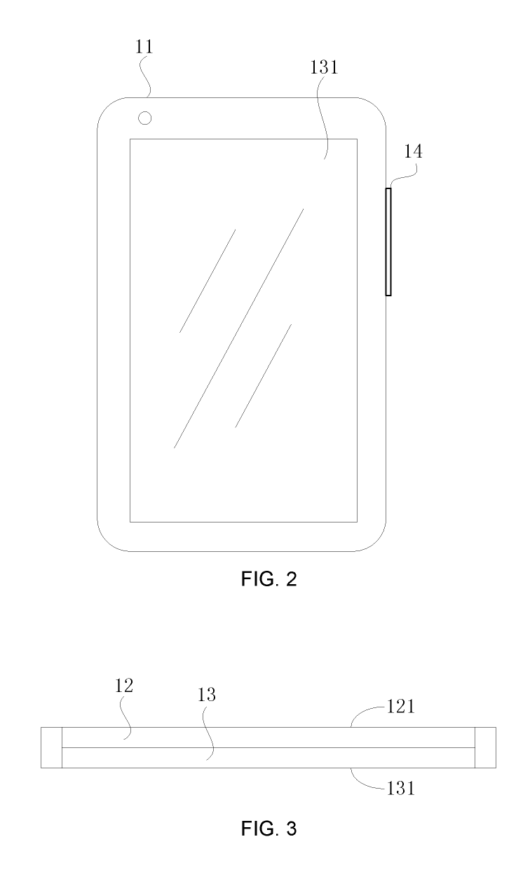

Referring to FIG. 1 and FIG. 2, in an embodiment of the disclosure, the first screen 12 is a transmission liquid crystal display, the second screen 13 is a reflection liquid crystal display. The transmission liquid crystal display employs a backlight to light the screen. The mobile terminal further includes a control switch 14.

In the embodiment, the control switch 14 is a physical switch disposed on external side of the shell 11, applied to select the first screen 12 or the second screen 13 to display, and when one of the first screen and the second screen displays, the other one is turned off. Therefore, a user can make the mobile terminal 10 to display through the first screen 12 or the second screen 13 depending on requirements. For instance, the transmission liquid crystal display with merits such as high resolution, high contrast, wide color gamut can provide vivid images, hence under the circumstances like watching videos or images, a user can select the mobile terminal 10 to display through the first screen 12 by the control switch 14, which can achieve better watching experience. The reflection liquid crystal display does not need a backlight, instead relaying on surrounding light to radiate the screen to display, so when surrounding is dim or the mobile terminal 10 is with low battery or only for purpose of reading, a user can select the mobile terminal 10 to display through the second screen 13 by the control switch 14, which can reduce the energy consumption of the mobile terminal 10 and prolong endurance.

After the mobile terminal 10 is started (such as pressing a power key), the mobile terminal 10 can select any one of the screens to display, or display an image through the screen selected last time. When the control switch 14 is pressed, the working screen being the first screen 12 or the second screen 13 is detected, if the first screen 12 is working, the working screen is shifted to be the second screen 13 by pressing the control switch 14, simultaneously the first screen 12 is shut off; if the second screen 13 is working, the working screen is switched to be the first screen 12 by pressing the control switch 14, simultaneously the second screen 13 is shut off. In doing so the two screens can be switched.

The control switch 14 is applied to select the second screen 13 to work and the first screen to be shut off under the following situations:

Situation 1: remaining capacity of a battery of the mobile terminal 10 is lower than a first threshold. The first threshold can be 10%, 15% or 20% of the total capacity. That means when remaining capacity of a battery of the mobile terminal 10 is lower than a first threshold, a user can press the control switch 14 to make the mobile terminal 10 to select the second screen 13 to work.

Situation 2: the mobile terminal 10 is under the circumstances that brightness is higher than a second threshold. That means when the surrounding is bright, a user can press the control switch 14 to make the mobile terminal 10 to select the second screen 13 for display. The mobile terminal 10 monitors brightness of the surroundings, when the brightness is higher than the second threshold, a notice of “brightness achieved” can be sent, a user can decide whether to switch screens according to the notice.

Situation 3: the mobile terminal is running a preset application. The preset application can be an e-book, wechat, QQ, etc. When the mobile terminal is running the preset application, a user can press the control switch 14 to make the mobile terminal 10 to select the second screen 13 to work.

Obviously, in another embodiment, the control switch can be a software, such as a touch key shown on the screen. For instance, the control switch can be placed in the main menu, when a user needs to switch the first screen 12 and the second screen 13, the control switch can be found from the main menu, which can be touched to switch the working screen. Specifically, when the first screen 12 is working, when the control switch is touched, the working screen will be switched to be the second screen 13; when the second screen 13 is working, when the control switch is touched, the working screen will be switched to be the first screen 12.

Moreover, in another embodiment, the first screen 12 and the second screen 13 can be switched automatically. For instance, when the mobile terminal 10 detects remaining capacity of a battery of the mobile terminal is lower than a first threshold, or the mobile terminal is under the circumstances that brightness is higher than a second threshold, or a preset application starts to run, if the first screen 12 works, the mobile terminal 10 will select to display the second screen 13, which is a switch from the first screen 12 to the second screen 13; if the second screen 12 works, it will be maintained. When remaining capacity of a battery of the mobile terminal is not lower than the first threshold, and the mobile terminal is under the circumstances that brightness is not higher than the second threshold as well asno preset application can be detect to be running, the working screen should not be switched, or the first screen 12 is selected.

In another embodiment of the disclosure, the second screen 13 is a commonly white mode reflection liquid crystal display, which means the second screen 13 is highly reflective and capable of penetrating lights without being loaded a liquid crystal drive voltage, the second screen 13 can penetrate lights when loaded a liquid crystal drive voltage. Therefore, the second display panel 131 of the second screen 13 of the embodiment is reflective without being loaded a voltage, identically a mirror.

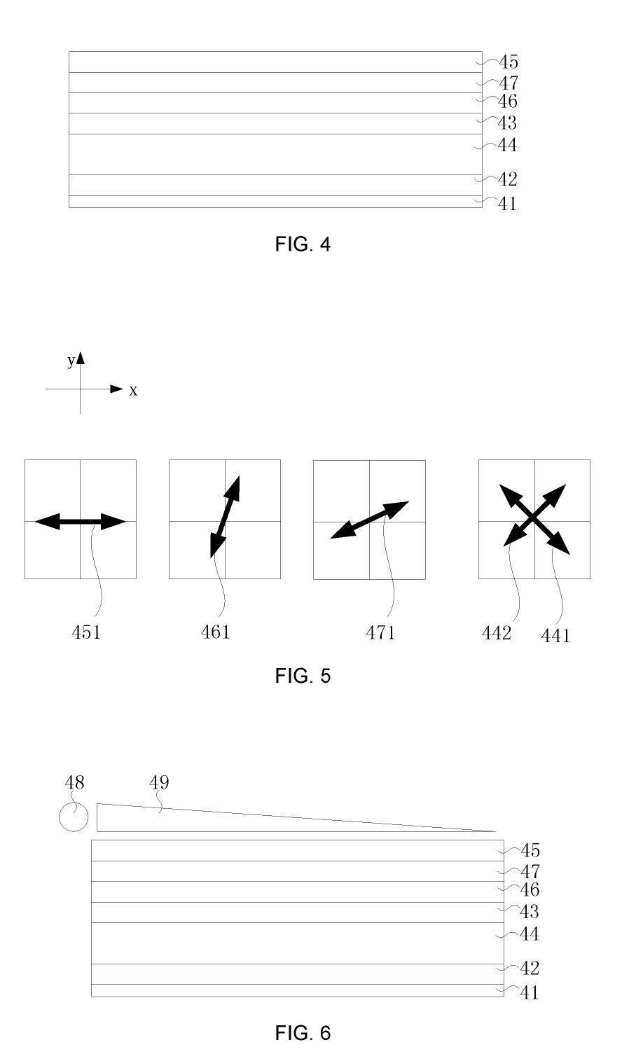

Referring to FIG. 4, in the embodiment, the second screen 13 includes: a first substrate 42 with a reflecting layer 41; a second substrate 43; a liquid crystal layer 44 between the first substrate 42 and the second substrate 43; a polarizer 45 disposed on the second substrate 43.

The polarizer is on a side that is close to the second display panel 131. The first substrate 42 is an array substrate applied to form a pixel array, the second substrate 43 is a color filter substrate. Ambient lights enter through the polarizer 45, turned to be polarized lights by the polarizer 45, pass through the second substrate 43, the liquid crystal layer 44, the first substrate 42 and reach the reflecting layer 41, reflected by the reflecting layer 41 and emit from the polarizer 45.

In order to even the brightness of the screen, a reflecting surface of the reflecting layer 41 is concave-convex, diffuse reflection occurs when lights strike on the reflecting surface of the reflecting layer 41.

Furthermore, the second screen 13 further includes a quarter wave plate 46 and a half wave plate 47. The quarter wave plate is disposed in back of the polarizer in a direction of radiating light. The direction of radiating light means a direction from the reflecting layer 41 to the polarizer 45. The half wave plate 47 is disposed between the quarter wave plate 46 and the polarizer 45.

As shown in FIG. 5, in the embodiment, in FIG. 5, a penetration axis 451 of the polarizer 45 is parallel to x axis, which equals to an angle between the x axis and the penetration axis 451 is 0°, an angle between a fast axis 461 of the quarter wave plate 461 and the x axis is 80°, an angle between a fast axis 471 of the half wave plate 47 and the x axis is 17.5°, and an angle between an alignment direction of a liquid crystal 441 on a side close to the first substrate 42 and the x axis is 140°, an angle between an alignment direction of a liquid crystal 442 on a side close to the second substrate 43 and the x axis is 50°.

Obviously, in other embodiments, directions of the penetration axis of the polarizer 45 and fast axes of the quarter wave plate 46 and the half wave plate 47 can be adjusted, such as the penetration axis of the polarizer 45 can be perpendicular to the x axis. In addition, the alignment of the liquid crystal layer 44 can be twisted nematic (TN), or vertical alignment (VA), or in-plane switching (IPS), or other sorts of alignments.

Obviously, in other embodiments, the second screen 13 can also be a commonly white mode reflection liquid crystal display with other structures without limitation. The second screen 13 can be a commonly black mode reflection liquid crystal display. And the first screen 12 and the second screen 13 can both be reflection liquid crystal displays.

Referring to FIG. 6, in another embodiment of the disclosure, as a reflection liquid crystal display, the second screen 13 further includes a light source 48, the light source 48 is a front light source disposed on a side of the second screen 13, as shown in FIG. 6, the light source 48 is disposed on a side close to the polarizer 45.

The light source 48 assists ambient lights to display. When it is dim, the light source 48 can be turned on for a clear display. The light source 48 can be turned on/off by a physical switch, or automatically depending on brightness of surroundings. For instance, when brightness is detected to be lower than a threshold and the second screen 13 is working, the light source 48 will be turned on automatically for a better display, when brightness of surroundings is larger than or equal to the threshold and the second screen 13 is working, the light source 48 will be turned off to save energy.

In an embodiment, the power of the light source 48 is less than that of a backlight of the first screen 12, which can be regarded as a transmission liquid crystal display.

Moreover, in order to even the brightness of display, the second screen 13 further includes a light guide plate 49, the light guide plate 49 is disposed on the polarizer 45, applied to lead the light from the light source 45 to the polarizer 45, for entering through the polarizer 45.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A mobile terminal, wherein it comprises a first screen and a second screen;
the first screen having a first display panel, the second screen having a second display panel, a direction of the first display panel and that of the second display panel opposite, the first screen being a transmission liquid crystal display, the second screen being a reflection liquid crystal display, and when one of the first screen and the second screen works, the other one turned off;
when the mobile terminal detecting remaining capacity of a battery lower than a first threshold, or detecting brightness higher than a second threshold, or detecting a user issuing an initial command of a preset application, the mobile terminal opting for the second screen to display an image.

2. The mobile terminal according to claim 1, wherein the reflection liquid crystal display is a commonly white mode reflection liquid crystal display.

3. The mobile terminal according to claim 2, wherein the reflection liquid crystal display comprises:
a first substrate with a reflecting layer;
a second substrate;
a liquid crystal layer between the first substrate and the second substrate;
a polarizer disposed on the second substrate.

4. The mobile terminal according to claim 3, wherein the reflection liquid crystal display further comprises a quarter wave plate, the quarter wave plate is disposed in back of the polarizer in a direction of emitting light.

5. The mobile terminal according to claim 4, wherein the reflection liquid crystal display further comprises a half wave plate, the half wave plate is disposed between the quarter wave plate and the polarizer.

6. The mobile terminal according to claim 3, wherein the reflection liquid crystal display comprises a light source, the light source is disposed on a side of the reflection liquid crystal display.

7. The mobile terminal according to claim 3, wherein a reflecting surface of the reflecting layer is concave-convex.

8. A mobile terminal, wherein it comprises a first screen and a second screen;
the first screen having a first display panel, the second screen having a second display panel, a direction of the first display panel and that of the second display panel opposite, the first screen being a transmission liquid crystal display, the second screen being a reflection liquid crystal display, and when one of the first screen and the second screen works, the other one turned off.

9. The mobile terminal according to claim 8, wherein it comprises a control switch, applied to select the first screen or the second screen to display an image.

10. The mobile terminal according to claim 9, wherein the control switch is applied to select the second screen to display in one of following conditions, and retain the first screen closed:
remaining capacity of a battery of the mobile terminal lower than a first threshold;
the mobile terminal under the circumstances that brightness higher than a second threshold;
the mobile terminal running a preset application.

11. The mobile terminal according to claim 8, wherein the first screen is a transmission liquid crystal display, the second screen is a reflection liquid crystal display.

12. The mobile terminal according to claim 11, wherein the reflection liquid crystal display is a commonly white mode reflection liquid crystal display.

13. The mobile terminal according to claim 12, wherein the reflection liquid crystal display comprises:
a first substrate with a reflecting layer;
a second substrate;
a liquid crystal layer between the first substrate and the second substrate;
a polarizer disposed on the second substrate.

14. The mobile terminal according to claim 13, wherein the reflection liquid crystal display further comprises a quarter wave plate, the quarter wave plate is disposed in back of the polarizer in a direction of emitting light.

15. The mobile terminal according to claim 14, wherein the reflection liquid crystal display further comprises a half wave plate, the half wave plate is disposed between the quarter wave plate and the polarizer.

16. The mobile terminal according to claim 13, wherein the reflection liquid crystal display comprises a light source, the light source is disposed on a side of the reflection liquid crystal display.

17. The mobile terminal according to claim 13, wherein a reflecting surface of the reflecting layer is concave-convex.
